(19) United States
(12) Patent Application Publication
(10) Pub. No.: US 2006/0282287 A1
(43) Pub. Date: Dec. 14, 2006

(54) System for providing integrated healthcare management services

(76) Inventors: Laurence M. McKinley, Rancho Santa Fe, CA (US); Steve Saar, Carlsbad, CA (US); Robert Cherry, Irvine, CA (US); Daniel Kortman, San Clemente, CA (US)

Correspondence Address: CHRISTIE, PARKER & HALE, LLP, PO BOX 7068, PASADENA, CA, 91109-7068, US

(21) Appl. No.: 11/184,363

(22) Filed: Jul. 18, 2005

Related U.S. Application Data
(60) Provisional application No. 60/689,504, filed on Jun. 10, 2005.

(51) Int. Cl. G06Q 99/00; G06Q 10/00

(52) U.S. Cl. 705/2; 705/1

(57) ABSTRACT

A system for reducing the costs associated with providing medical care associated with the provision of specialized medical equipment and service is provided. In such a system a common management organization; a group of physicians; and a medical manufacturing, supply, and/or equipment company partner together to provide discounted medical supplies to a hospital or outpatient facility, thereby reducing costs across the healthcare system and creating additional resources within the current medical regulatory framework.

### RELATED APPLICATIONS

This application claims priority to Provisional Patent Application Ser. No. 60/689,504 filed Jun. 10, 2005, the disclosure of which is incorporated herein by reference

### FIELD OF THE INVENTION

The present invention relates to the provision of integrated healthcare services; and more particularly to a system for the controlled integration and distribution of medical supplies and technology, other healthcare services, and fees between the relevant goods and services providers, physicians, and hospitals through a centralized management entity.

### BACKGROUND OF THE INVENTION

A number of causes and solutions have been proposed to address the rapidly escalating cost of healthcare in America. One system introduced over the past few decades in an attempt to contain costs is the health maintenance organization (“HMO”), which can broadly be described as a healthcare management system that negotiates rates between medical service and device providers, such as medical device manufactures, drug companies, etc., and the physician. However, many significant disadvantages exist within this system. First, decisions concerning appropriate healthcare costs are generally made by healthcare administrators not physicians, and therefore these decisions are often more concerned with containing costs and not the needs of the patient. In addition, often substantial waste still exists because these administrators do not have an appropriate context for judging the value and actual cost of the medical devices, drugs, etc. they are judging.

In addition to these problems, which are more problematic for patients, physicians are also often disadvantaged by this system. For example, in many areas of medicine, doctors take an active hand in furthering the development of the field. For example, advances in the orthopedic and neurological fields often come from within the population of practicing physicians. However, the structure of the current healthcare system discourages these physicians from pursuing their innovations or even from utilizing the “best” tools available to them. The principal reason for this failure lies in the HMO structure. The HMO sets the “market” price for a particular medical implement. Even if the physician were to invent or even be aware of a cheaper more effective device, the HMO would not necessarily approve the “out-of-system” device, nor would any of the cost savings be passed on to the physician to offset the development costs. In light of this disincentivizing reality, many physicians currently allow their innovations to go unused to avoid the costs associated with the development, testing, manufacture and approval processes.

Finally, even were a physician to go through the expense of developing a medical innovation into a useable product, current Federal law, as set forth in the Social Security Act, including Stark II (42 U.S.C. 1395 nn) and the Anti-Kickback Statute (42 U.S.C. 1320(a)7b(b)), prohibits physicians from receiving direct payments for referring or using those innovations in patients. Although these provisions of the Social Security Act were designed with the noble goal of preventing physicians from improperly receiving “kickbacks” for directing people to use devices or services from which they derive direct compensation, this regulatory structure makes it even more difficult for physicians to integrate their own innovations in their practices, or even to encourage others within the profession to use those innovations, further disincentivizing such development efforts.

Accordingly, a need exists for an improved integrated and cooperative healthcare system capable of encouraging physician based innovation while maintaining the necessary statutory distance between the physician and the actual distribution of medical devices.

### SUMMARY OF THE INVENTION

The present invention is broadly directed to a system for integrating the provision of healthcare services between medical equipment and service providers and physicians under an umbrella cooperative organization to reduce costs across the entire healthcare chain, facilitate the propagation of new medical technologies, and generate a dividend for physicians.

In one embodiment, the system includes a centralized management entity which is supported by a collective group of physicians that has agreements with at least one medical device or services companies such that sales services are provided by the management entity and compensation rebates or discounts are provided to the management entity by the participating products or services providers when specified goods and services are utilized by a member of the physician collective group. In such an embodiment, the management entity passes the net revenues after management expenses along to the physicians' group as a dividend such that additional income is realized by the physicians.

In another embodiment, the cooperative management entity coordinates the intellectual property rights between the physicians and providers such that the providers can operate without negotiating individual patent, trademark, or copyright agreements with each physician.

In still another embodiment, the goods providers provide medical instruments or devices, such as orthopedic products, operating room materials, orthobiological material, or rehabilitation equipment to physicians of the group.

In yet another embodiment, the goods providers provide medications to physicians of the group.

In still yet another embodiment, the service providers provide malpractice insurance, office management, or consultation services to physicians of the group.

In still yet another embodiment, the management entity will contract and supervise clinical trials and research of medical devices and pharmacological materials with the physician group.

In still yet another embodiment the management entity will provide consultation services with hospitals, health plans concerning cost-containment and price savings.

### BRIEF DESCRIPTION OF THE DRAWINGS

These and other features and advantages of the present invention will be better understood by reference to the following detailed description when considered in conjunction with the accompanying drawing wherein:

FIG. 1 provides a flowchart of an integrated healthcare management system in accordance with the current invention.

FIG. 2 provides a flowchart of the steps of operation of an integrated healthcare management system in accordance with the current invention.

FIG. 3 provides a flowchart of the intellectual property arrangement of an integrated healthcare management system in accordance with the current invention.

FIG. 4 provides a flowchart of the regulatory compliance of an integrated healthcare management system in accordance with the current invention,

### DETAILED DESCRIPTION OF THE INVENTION

The current invention is directed to an improved integrated healthcare management system for integrating the provision of healthcare services between medical equipment and service providers and physicians to reduce costs across the entire healthcare chain and generate additional dividend income for physicians, herein referred to as “the system” or “the healthcare system”. The system includes a management entity, a group of physicians, at least one medical device or services provider, and a hospital or surgery center. The management entity is comprised of physicians, sales personnel and legal specialist to allow for full-service of the physicians group, and has a sales/distribution agreement with the at least one provider that generates income from commissions paid by the provider based on sales of the provider's products by the management entity. The net profit realized by the management entity after expenses is paid as a dividend to the cooperative physician group. In such an embodiment, the commissions and/or savings can be passed from the management entity to the physician group on a pro-rata basis to incentivize their cooperation in the system. Using this system the indirect participants, such as the hospitals and patients benefit from cost savings, and the physicians are incentivized by the dividend distribution for this cost containment and their lost autonomy.

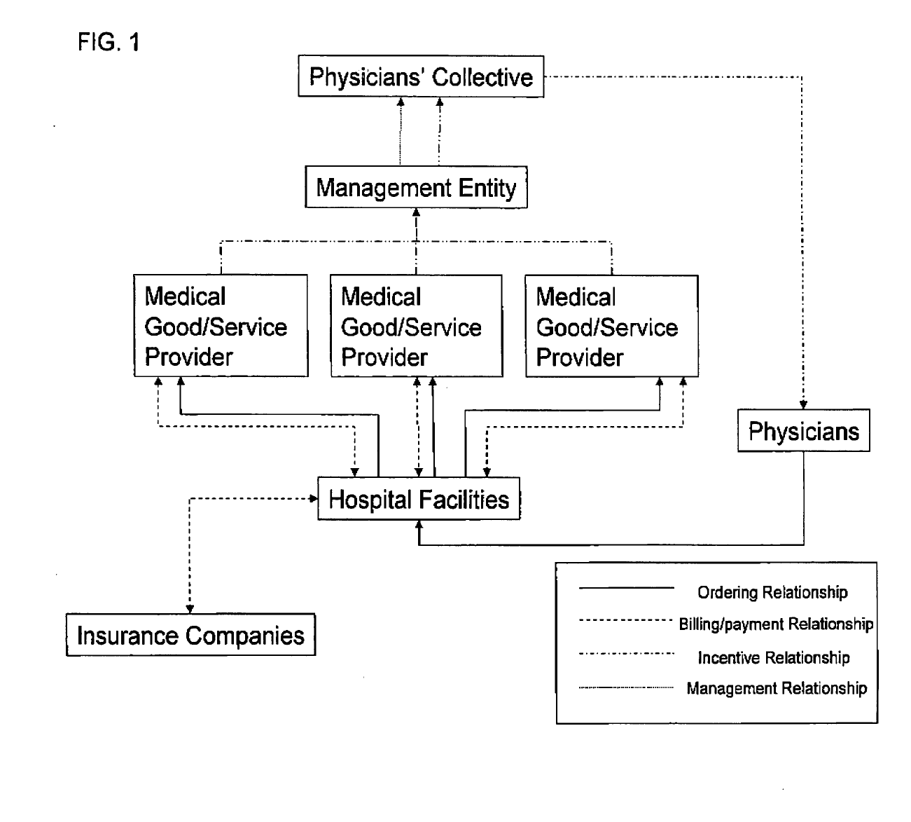

A flow-chart showing the elements and interconnectivity of the various elements of the system in accordance with the current inventive system is shown in FIG. 1. As shown, the principal elements of the system include health service and medical device providers 10, physicians 12, hospitals 14, and the physician's collective 16 and the central management entity 18. In the following discussion it should be understood that while these elements make up the essential pieces of the current healthcare management system, other pieces, such as multiple medical device providers, or further management intermediaries may be inserted between, for example, the physicians and the management company, or the hospitals and the management company such that further management services or collective benefits can be realized.

In summary, a group of physicians 12 form a group or collective 16 this collective has a management agreement with the management entity 18 such that the management company serves as the managing member of the physicians' collective 16. The management entity in turn has a sale agency agreement and discount contracts with at least one medical service or device provider 10. The management entity oversees discounts benefiting the recipients of care, namely the patients and hospitals, and in turn pass those savings along to the physicians in the group in the form of dividends based on each physician's ownership in the collective or group. When an order is placed by a physician within the collective 16 for goods or services from a participating provider 10 the order is placed to the provider through the normal hospital procedures, such that the hospital bills the appropriate insurance agency and pays the provider. In turn the provider pays commissions or provides discounts to the management entity, which then distributes the profit, after expenses, to the individual physician group in the form of dividends based on each physician's stake in the group.

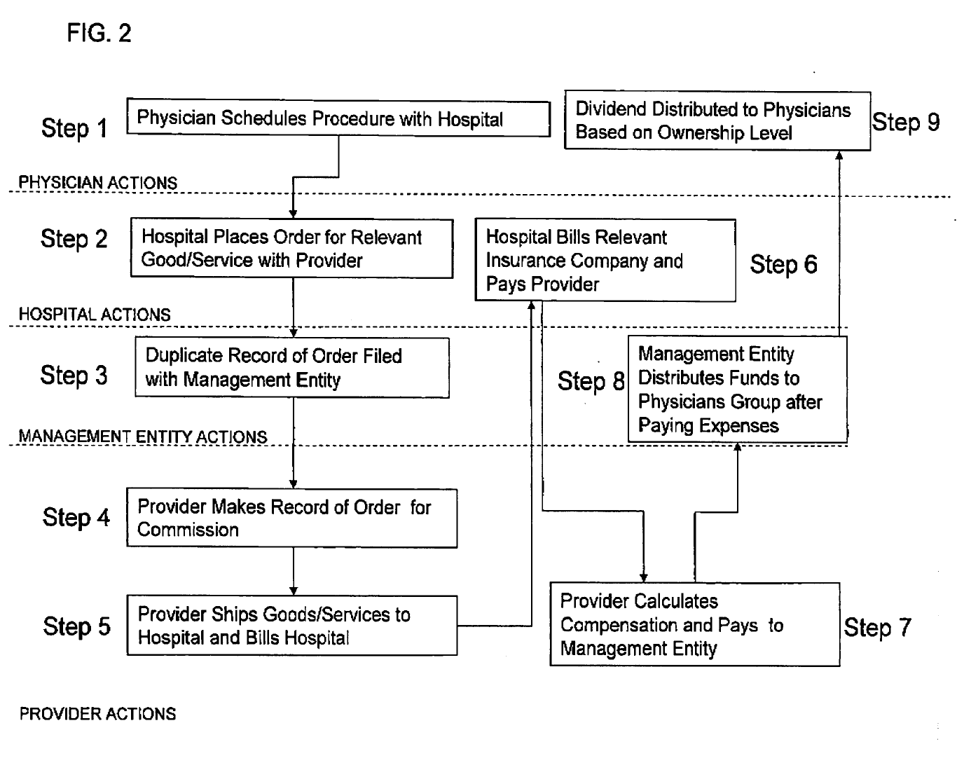

In operation the system works in accordance with the flowchart provided in FIG. 2. As shown, first a medical procedure is scheduled in a hospital by one of the physicians within the collective (Step 1) that uses a product or service from one of the providers within the system plan. The order is placed by the hospital to the provider through its normal ordering procedure (Step 2). Parallel with this, the management group, acting as the sale agent for the provider keeps a record of the specific goods and services used and whether those goods and services are being used on a patient with federally subsidized insurance, and issues a communication with that information to the provider (Step 3). The goods and/or services provider and the management entity both keep an account of the cost of the goods and services generated by the management entity and which of those purchases used a federal insurance program to ensure appropriate commissions and dividends are paid (Step 4). The provider then forwards the requested goods/services to the hospital (Step 5). The hospital bills the appropriate payer, such as a private or federal insurance company, and sends an appropriate payment to the provider for the goods or services (Step 6). At some period specified by the agreement a commission based on the total of the sales generated by the procedure minus any sales that result from federal insurance programs is paid by the provider to the management entity based on a fixed schedule (Step 7). The management entity then applies those commissions to any expenses generated by the entity and distributes the remainder through the collective (Step 8) to the individual physicians based on their ownership stake in the collective.

By integrating the provision of treatment with the sale of medical goods and services a number of cost savings and advantages are realized. First, the medical goods/services providers are not required to hire their own sales staff, because the management entity is working as a built-in sales force. Second, having a direct relationship with a particular medical good/service provider allows for individual physicians to simplify their practices by gaining expertise with a particular set of physician related tools, which would otherwise be determined by the hospital or by an outside HMO. Third, having a direct relationship with the good/service providers allows for closer cooperation between physician and supplier allowing for the rapid creation of new innovative products and custom goods and services based on a particular physician's needs. Finally, because intellectual property rights are designed into the agreement between the goods/services providers and the physicians' collective, significant cost saving advantages and operating freedom can be realized within the heavily patent oriented medical device field. Accordingly, advantages of the current healthcare management system include:
simplifying surgical techniques for physicians by allowing for a single set of goods/services providers chosen by the physician;
allowing the physician to become specialized with a specific set of goods/services thereby increasing positive patient outcomes;
allow for cooperative arrangements between providers and physicians such that new and custom goods/services can be provided;
allow for the collective ownership of necessary intellectual property rights;
reduce expenses by reducing expensive sales force and sales representative overhead; and
increasing the efficiency and reducing expenses in a market where price control is of principal concern, and annual increases in prices regularly exceed the rate of inflation.

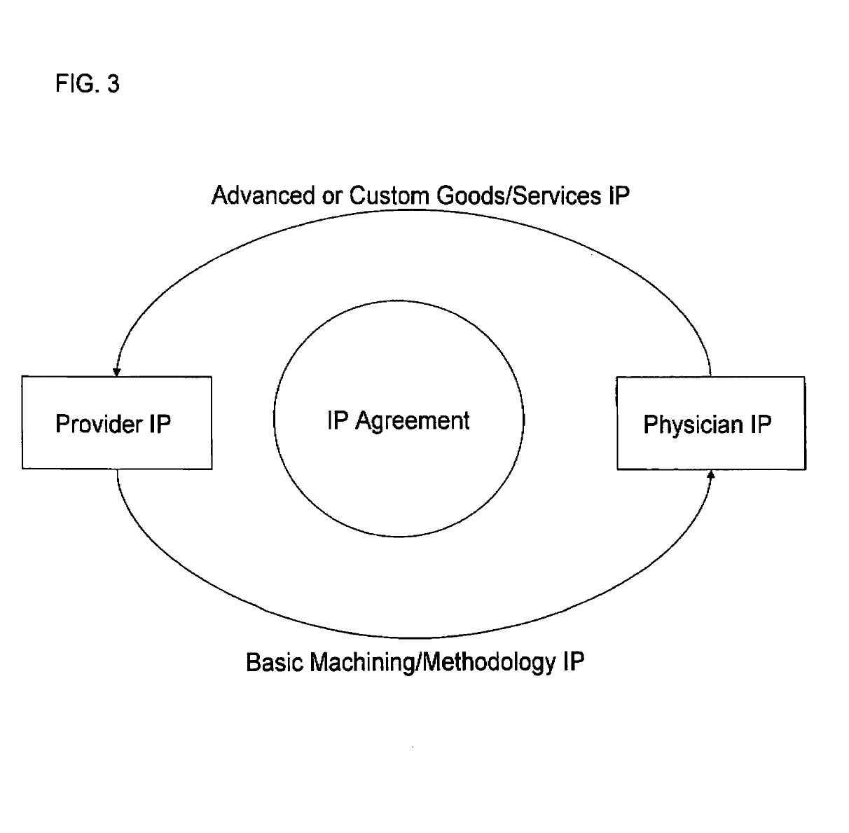

With regard to the development of additional goods and services by and between the members of the management group and the goods/services providers, it should be understood that the such intellectual property may flow in either direction, as shown in the flowchart of FIG. 3. For example, when a physician created innovation is developed that innovation would be offered through the managing entity to an appropriate goods/services provider for licensing from the collective. Likewise, intellectual property rights owned and developed by one of the goods/services providers could be licensed to members of the physicians collective to allow those physicians greater freedom to use a variety of techniques and tools in their practices.

The different components of the healthcare management structure defined by the current invention and the nature of the relationships between the various components are necessary to allow for a cooperative healthcare structure that allows for incentives for physician directed goods and services delivery within the specialized regulatory environment of the healthcare industry. Two regulatory structures within the Social Security Act (“SSA”) are implicated where physicians attempt to either direct the use of, or use a set of goods and services to which they have a direct or indirect financial connection—the Stark II (1877 of SSA (42 U.S.C. 1395 nn)), and the Anti-Kickback Statute (1128B(b) of SSA (42 U.S.C. 1320(a)-7b(b))). The details of these regulations are discussed further below, however, it is the presence of these regulatory structures that has effectively thwarted past attempts to construct physician managed healthcare systems, and it is the legal operation within these regulatory structures that the current healthcare management system allows.

Stark II prohibits physicians from referring patients for the furnishing of “designated health services” to an entity with which the physician or an immediate family member has a financial relationship if the services will be covered in whole or in part by Medicare. Designated health services are defined by the act and include a myriad of treatments and procedures, including: clinical laboratory services, physical therapy services, radiology services, radiation therapy, durable medical equipment and supplies, nutrients, prosthetics, prescription drugs, etc. Likewise, under Stark II any financial relationship including investments or compensation relationships whether direct or indirect between referring physicians and a particular goods or services provider is implicated. Accordingly, integrated healthcare systems in which physicians and goods/services providers play a cooperative role have typically been found to be improper. The healthcare of the current system is purposefully designed to comply with all applicable federal regulations.

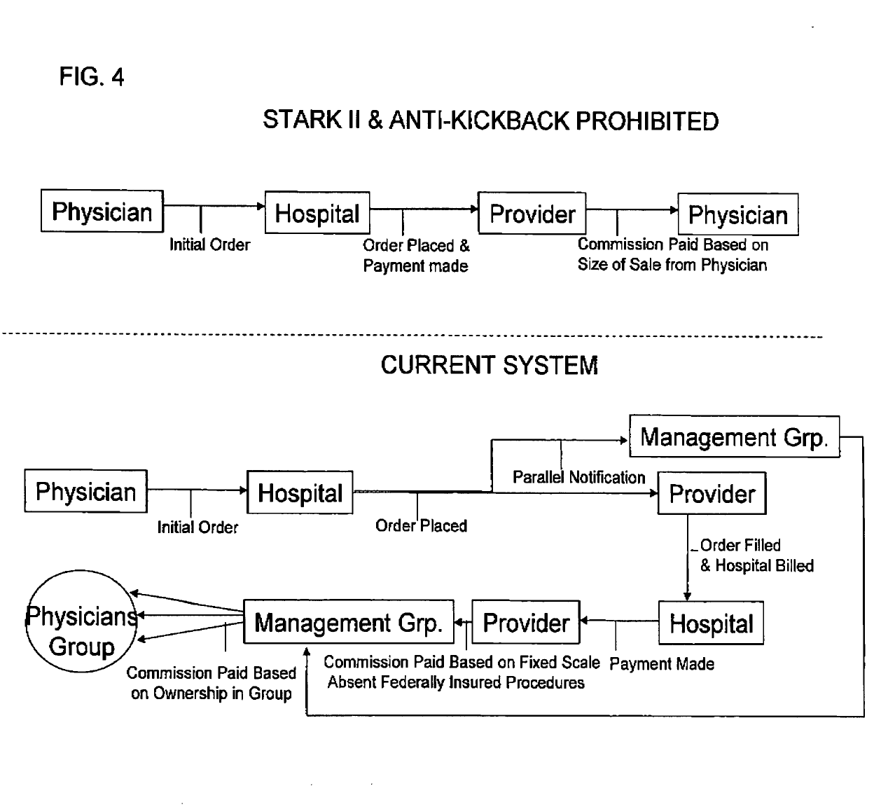

FIG. 4 provides a flowchart that compares the current healthcare system, with a system that would not be allowed to function under Stark II. As shown, under the inventive healthcare system a physician schedules a patient for a procedure and selects a good or service from one of the plan providers. The selected goods/services are then billed through the hospital. Although the physician clearly has a relationship with the provider based on the commission and incentive structure discussed above, under Stark II a referral exists only with the entity that directly bills Medicare, which in this case is the hospital. Although the structure avoids any Stark II violations for direct compensation as between the providers and the physicians, the physicians still refer patients to a hospital and so this referral would implicate the indirect compensation regulations under Stark II. In this case, as shown in FIG. 4, the indirect relationship under the current inventive system originates with the physician who refers a patient to a hospital or clinic. The Hospital then bills a payer and pays the providers for the relevant goods or services. The provider would then pay the relevant commission to the management entity, which, after paying expenses in accordance with common accounting practices, would distribute to the physician group dividends on an agreed upon schedule, such as at the end of the fiscal year. Accordingly, additional protections must be built into the system to ensure that none of the indirect compensation provisions of Stark II are violated. To implicate the Stark II indirect compensation provisions the following elements must be met:
1. There must exist an unbroken chain of persons or entities that have financial relationships between the referring physician and the hospital;
2. The compensation received by the referring physician has a direct relationship that varies with the volume of referrals generated by the physician; and
3. The hospital must have actual knowledge of the compensation scheme.

Two factors within the structure of the current healthcare system eliminate the second element of Stark II. First, no compensation is collected for procedures paid under federal insurance programs, and indeed, one of the principal features of the system is that the nature of the payer is analyzed prior to a commission being paid, e.g., Steps 4 to 6 of FIG. 2. Accordingly, the compensation is not directly related to the volume of referrals. Moreover, there is a safe-harbor within Stark II where:
1. The compensation does not take into account the value or volume of referrals, such as through a fixed-fee schedule;
2. The compensation agreement between the physician and the compensating entity is in writing; and
3. The compensation does not violate the Anti-Kickback Statute.

Under the current system clearly falls within the safe harbor as the compensation provided to the collective does not take into account procedures conducted under federal insurance programs and uses a fixed-fee schedule developed between the providers and the collective, the system is operated under an explicit written agreement between the collective and the providers, and as discussed below the system does not implicate the Anti-Kickback Statute.

The Anti-Kickback Statute is designed to work in conjunction with the Stark II provision of the SSA and prohibits anyone from knowingly and willingly soliciting and receiving any remuneration directly or indirectly in return for referring or purchasing any good or service for which payment is made in whole or in part under a Federal healthcare program. However, there are several structural elements of the inventive healthcare system that uniquely allow for the operation under the Anti-Kickback Statute
The agreement between the provider and the collective is set out in writing and covers all the services and goods to be provided under the agreement.
The transaction is consistent with the fair-market-value of the goods and services and avoids compensation based on goods and services provide under federal insurance programs.

Accordingly, the nature of the relationships between the providers, the collective, the hospitals, and the physicians along with the payment and compensation relationships allows for the operation of an integrated collective physician managed healthcare system within the constraints of this specialized federal healthcare regulatory structure.

### EXAMPLES

The above general discussion will be better understood with reference to the following non-limiting examples:

In one exemplary system a healthcare system is provided for spinal procedures. In such a system, a group of spinal physicians would form a collective that would be run by a managing entity. This management entity would then enter into a sales agreement with a particular spinal hardware provider. The sales agreement would set forth at least two points: that the management entity is to operate as the sales agent for the spinal hardware provider, and that in turn members of the collective are to have unparalleled access to manufacturer to allow for the close cooperation of the two. The sales agreement would also specify the prices for standard spinal hardware and provide fixed commission levels for each piece of hardware. Such a commission level could be based on a percentage of the price of the piece, or could vary based on the relative complexity or rarity of each piece.

During the operation of the system, a physician would schedule a procedure at a particular hospital and, if in his medical judgment it would be appropriate, would chose a piece of hardware provided by the cooperative spinal hardware provider. The hospital would then order the necessary spinal hardware from the provider. The provider would take this information, supply the necessary parts and bill the hospital. The hospital would in turn pay the provider. When the hospital orders the necessary hardware or other medical materials, parallel documentation would be developed as between the management entity and the provider such that the management entity could monitor the process and ensure appropriate commission levels are provided to the management entity for distribution to the physician group. At specified intervals the provider would review its records and provide commissions to the management entity based on sales made to patients of the physicians group minus any sales based on federally funded procedures.

In addition to the dividends received by the physicians, the agreement would also foster a cooperative environment between the physicians and the providers with regard to intellectual property such that a physician could pursue the manufacture of improved instruments of their own proprietary design with the provider under a predefined intellectual property agreement, and could also rely on being able to use any proprietary manufacturing technologies owned by the manufacturer. Accordingly, the design, testing, manufacture, and provision of novel spinal instruments could be accelerated via the cooperative structure of the inventive healthcare system.

Although only agreements within the spinal field are discussed above, it should be understood that any field where a provider and physician can cooperatively interact is implicate by the current invention. For example, other exemplary areas of cooperative interaction include:
Malpractice Insurance: such as developing and finding defense experts and preparing defense strategies cooperatively with a legal services organization.
Medication/Drug Distribution: such as the distribution and marketing of medicines used in treatment of relevant disorders cooperatively with pharmaceutical companies.
Office Management: the provision of assistance with business management organization, such as staff and supply management.
Consultation Services: the cooperative development of consultation services by and between physicians, hospitals, manufacturing companies, etc. such as, for example, advice concerning marketing, contracting, cost containment, intellectual property protection, and product development.
Medical Products: such as, for example:
   hardware, such as orthopedic supplies like prosthesis, implants, etc.
   soft goods, such as braces, splints, etc.
   orthobiologic compounds, such as, bone grafts and other orthobiological compounds.
   operating room materials, such as, physician supplies, anesthesia supplies, etc.
   rehabilitation equipment, such as, therapist staffing and supplies.
Clinical Trial Services: such as, for example, providing testing companies with access to members of the collective to perform requested clinical trials on appropriate subject patients.
Other Markets; such as, for example, neurological device implants, ENT equipment for surgery, ophthalmology, etc.

In addition, although only single cooperative agreements are discussed above, it should be understood that any mix of providers and physicians' collectives could be included in agreements by and between the collective and physicians, such as a mix of surgical goods and rehabilitation services for a number of different physicians' groups.

Further, although specific embodiments and exemplary embodiments are disclosed herein, it is expected that persons skilled in the art can and will design alternative integrated healthcare systems and methods of providing integrated healthcare services that are within the scope of the following claims either literally or under the Doctrine of Equivalents.

What is claimed is:

1. A regulatory compliant integrated healthcare system comprising:
a management entity;
a medical collective consisting of and owned by a plurality individual physicians wherein the management entity has an ownership stake in the medical collective and provides management services thereto;
at least one medical goods or services provider; and
a cooperative agreement between said management entity, said medical collective, and said at least one medical goods or services provider, the cooperative agreement comprising a sales agreement between the management entity and the at least one medical goods or services provider whereby the management entity acts as the sales agent for the medical goods or service provider, the medical goods or services provider pays a commission to the management entity based on the sales of said medical goods or services provider's goods or services by the individual physicians of the medical collective and other physician's clients, and wherein the management entity distributes dividends from said commission to the individual physicians of the medical collective based on said individual physicians equity position in the medical collective.

2. The healthcare system described in claim 1, wherein the cooperative agreement further comprises an intellectual property agreement between said medical collective and said medical goods or service provider such that intellectual property is freely exchangeable therebetween.

3. The healthcare system described in claim 1, wherein the management entity further operates as an intellectual property manager between the medical collective and the medical goods or services provider.

4. The healthcare system as described in claim 3 wherein the management entity as the intellectual property manager provides at least one service to one of either or both the medical collective or medical goods or services provider selected from the group consisting of representation of inventors in obtaining licenses, the provision of nondisclosure agreements, assistance with invention research, the creation of prototypes, and the prosecution of patent applications.

5. The healthcare system described in claim 1, wherein the management entity as sales representative negotiates prices between the medical goods or service providers and at least one external entity.

6. The healthcare system described in claim 1, wherein the external entity is selected from the group consisting of medical facilities, insurance companies, and third party payors.

7. The healthcare system described in claim 2, wherein the medical goods or services provider further pays commissions to the medical collective based on the use of intellectual property generated by members of the medical collective.

8. The healthcare system described in claim 1, wherein the system is compliant with all relevant provisions of the Social Security Act.

9. The healthcare system described in claim 8, wherein the relevant provisions of the Social Security Act are at least Stark II and the anti-Kickback Statute.

10. The healthcare system described in claim 1, wherein the cooperative agreement further comprises a clinical research agreement between the individual physicians of the medical collective such that the individual physicians within agree to provide a collective clinical research resource for external research studies.

11. The healthcare system described in claim 1, wherein the management entity further provides financial services to the medical collective.

12. The healthcare system described in claim 11, wherein the financial services are selected from the group consisting of pension plan administration, accounting services, billing services, collection services, and payroll services.

13. The healthcare system described in claim 1, wherein the management entity further provides practice management services to said collective.

14. The healthcare system described in claim 13, wherein the practice management services are selected from the group consisting of supply service, legal services and human resources services.

15. The healthcare system described in claim 1, wherein the management entity is further authorized to negotiate group prices for each physician within the collective for all external providers.

16. The healthcare system described in claim 1, wherein the cooperative agreement further comprises a custom order agreement, whereby individual physicians within the medical collective may directly order custom goods or services directly from the at least one goods or services provider at reduced costs.

17. The healthcare system described in claim 1, wherein the cooperative agreement further comprises an accounting agreement whereby purchases of goods or services from the goods or services provider paid for by a federal insurance program are not credited during calculation of the commission.

18. The healthcare system described in claim 1, wherein the cooperative agreement further comprises a fee schedule whereby a fixed price is set for each good or service offered to the individual physicians of the medical collective by the at least one goods or services provider.

19. A regulatory compliant integrated healthcare system comprising:
a management entity,
a medical collective consisting of and owned by a plurality individual physicians wherein the management entity has an ownership stake in the medical collective and provides management services thereto;
at least one medical goods or services provider; and
a cooperative agreement between said management entity, said medical collective, and said at least one medical goods or services provider, the cooperative agreement comprising:
a sales agreement between the management entity and the at least one medical goods or services provider whereby the management entity acts as the sales agent for the medical goods or service provider, the medical goods or services provider pays a commission to the management entity based on the sales of said medical goods or services provider's goods or services by the individual physicians of the medical collective and other physician's clients, and wherein the management entity distributes dividends from said commission to the individual physicians of the medical collective based on said individual physicians equity position in the medical collective;
an accounting agreement whereby purchases of goods or services from the goods or services provider paid for by a federal insurance program are not credited during calculation of the commission; and
a fee schedule whereby a fixed price is set for each good or service offered to the individual physicians of the medical collective by the at least one goods or services provider.

20. A method of providing healthcare comprising the steps of:
establishing a management entity;
establishing a medical collective owned jointly by a plurality of individual physicians wherein the management entity has an ownership stake in the medical collective and provides management services thereto;
forming a cooperative agreement between said management entity, said medical collective, and at least one medical goods or services provider to establish rights and responsibilities therebetween in procuring medical services and goods;
placing an order for at least one good or service by an individual physician through a hospital;
transferring said order from said hospital to the medical goods or services provider and said management entity;
shipping said medical goods or services from said medical goods or services provider to said individual physician at said hospital and billing said hospital;
calculating the total sales from all sales made by said medical goods or services provider generated by said management entity and said individual physicians of said medical collective;
paying a commission to said management entity from said medical goods or services provider based on the sales of said medical goods or services; and
distributing dividends from said commission to said individual physicians of the medical collective from said management entity based on said individual physicians equity position in the medical collective.

21. The method described in claim 20, wherein the cooperative agreement further comprises an intellectual property agreement between said medical collective and said medical goods or service provider such that intellectual property is freely exchangeable therebetween.

22. The method described in claim 21, wherein the management entity further operates as an intellectual property manager between the medical collective and the medical goods or services provider.

23. The method as described in claim 20 further comprising the step of promoting the procurement of intellectual property protection by the individual physicians of the medical collective by the management entity.

24. The method described in claim 20, further comprising the step of negotiating prices between the medical goods or service providers and at least one external entity through the management entity.

25. The method described in claim 24, wherein the external entity is selected from the group consisting of medical facilities, insurance companies, and third party payors.

26. The method described in claim 21, wherein the commissions is further based on the use of intellectual property generated by members of the medical collective.

27. The method described in claim 20, wherein the method is compliant with all relevant provisions of the Social Security Act.

28. The method described in claim 27, wherein the relevant provisions of the Social Security Act are at least Stark II and the anti-Kickback Statute.

29. The method described in claim 20, wherein the cooperative agreement further comprises a clinical research agreement between the individual physicians of the medical collective such that the individual physicians within agree to provide a collective clinical research resource for external research studies.

30. The method described in claim 20, wherein the management entity further provides financial services to the medical collective.

31. The method described in claim 30, wherein the financial services are selected from the group consisting of pension plan administration, accounting services, billing services, collection services, and payroll services.

32. The method described in claim 20, wherein the management entity further provides practice management services to said medical collective.

33. The method described in claim 32, wherein the practice management services are selected from the group consisting of supply service, legal services and human resources services.

34. The method described in claim 20, wherein the management entity further negotiates group prices for each physician within the medical collective for all external providers.

35. The method described in claim 20, wherein the cooperative agreement further comprises a custom order agreement, whereby individual physicians within the medical collective may directly order custom goods or services directly from the at least one goods or services provider at reduced costs.

36. The method described in claim 20, further comprising accounting for purchases of goods or services from the goods or services provider paid for by a federal insurance program such that such purchases are not credited during calculation of the commission.

37. The healthcare management system described in claim 20, further comprising setting a fee schedule whereby a fixed price is set for each good or service offered to the individual physicians of the medical collective by the at least one goods or services provider.

38. A method of providing healthcare comprising the steps of:
establishing a management entity;
establishing a medical collective owned jointly by a plurality of individual physicians wherein the management entity has an ownership stake in the medical collective and provides management services thereto;
forming a cooperative agreement between said management entity, said medical collective, and at least one medical goods or services provider to establish rights and responsibilities therebetween in procuring medical services and goods;
setting a fee schedule whereby a fixed price is set for each good or service offered to the individual physicians of the medical collective by the at least one goods or services provider;
placing an order for at least one good or service by an individual physician through a hospital;
transferring said order from said hospital to the medical goods or services provider and said management entity;
shipping said medical goods or services from said medical goods or services provider to said individual physician at said hospital and billing said hospital;
calculating the total sales from all sales made by said medical goods or services provider generated by said management entity and said individual physicians of said medical collective;
paying a commission to said management entity from said medical goods or services provider based on the sales of said medical goods or services;
distributing dividends from said commission to said individual physicians of the medical collective from said management entity based on said individual physicians equity position in the medical collective; and
accounting for purchases of goods or services from the goods or services provider paid for by a federal insurance program such that such purchases are not credited during calculation of the commission.
